(19) United States
(12) Patent Application Publication
(10) Pub. No.: US 2026/0350197 A1
(43) Pub. Date: Nov. 5, 2026

(54) Cross-Tenant Private Application Access

(71) Applicant: Zscaler, Inc., San Jose, CA (US)

(72) Inventors: Abhilash Tumkur Sathyanarayana, San Jose, CA (US); Jian Liu, San Jose, CA (US); Joby Menon, San Jose, CA (US); Omar Jaber, Seattle, WA (US); Mark Ryan, London (GB)

(73) Assignee: Zscaler, Inc., San Jose, CA (US)

(21) Appl. No.: 19/198,542

(22) Filed: May 5, 2025

(51) Int. Cl. G06F 21/62

(52) U.S. Cl. CPC G06F 21/6218

(57) ABSTRACT

Systems and methods for cross-tenant access to private applications includes establishing a trusted federation relationship within a private application access service between a host tenant and a guest tenant, the host tenant and the guest tenant being tenants of a cloud-based system operating the private application access service; evaluating access requests, by users of the guest tenant, to one or more private applications of the host tenant; creating a secure connection between a user of the guest tenant and a private application of the host tenant; and monitoring the connection via the private application access service.

### FIELD OF THE DISCLOSURE

The present disclosure relates generally to computing. More particularly, the present disclosure relates to systems and methods for cross-tenant private application access.

### BACKGROUND OF THE DISCLOSURE

In modern enterprise environments, secure and efficient collaboration between organizations is critical, particularly as businesses increasingly adopt cloud-native architectures and decentralized workforces. Many organizations leverage solutions to provide secure, granular access to private applications without exposing their networks to the public internet. However, as organizations expand their partnerships, mergers, and acquisitions, the need for seamless and secure cross-tenant private application sharing has become increasingly pressing. Existing approaches for enabling cross-tenant access, such as MPLS connections, site-to-site VPNs, or IP whitelisting, introduce operational complexity, high costs, and security risks. These traditional methods often fail to align with modern zero trust principles, as they rely on network-based trust models that increase the attack surface and are difficult to scale. Administrators, too, face challenges in configuring access policies, managing dependencies, and ensuring proper visibility and security across tenants. The present invention addresses these challenges by introducing a cross-tenant federation framework.

### BRIEF SUMMARY OF THE DISCLOSURE

The present disclosure relates to systems and methods for providing cross-tenant private application access. The present disclosure includes methods having steps, processing devices configured to implement the steps, a cloud-based system configured to implement the steps, and as a non-transitory computer-readable medium storing instructions for programming one or more processors to execute the steps. The steps include establishing a trusted federation relationship within a private application access service between a host tenant and a guest tenant, the host tenant and the guest tenant being tenants of a cloud-based system operating the private application access service; evaluating access requests, by users of the guest tenant, to one or more private applications of the host tenant; creating a secure connection between a user of the guest tenant and a private application of the host tenant; and monitoring the connection via the private application access service.

The steps can further include wherein an application connector of the host tenant is used to broker communication to the private application. The evaluating can include evaluating policies established by the guest tenant, wherein the policies govern which users are allowed access to which private applications of the host tenant. Monitoring the connection can include evaluating, based on policy, session timeout intervals and monitoring device compliance. The steps can include terminating the connection responsive to any policy violations. The secure connection between the user and the private application can be facilitated through a broker of the cloud-based system which evaluates federated access policy to ensure compliance. The broker can be adapted to identify an appropriate application connector within the host tenant's environment for creating the secure connection. Prior to establishing the connection, the steps can include verifying the users device posture including operating system type, operating system version, and antivirus status. The secure connection can be initiated by an agent application of a device associated with the user, which forwards an access request to a nearest cloud-based system broker for policy evaluation and enforcement. Upon successful policy evaluation, the connection allows application-specific access while prohibiting lateral movement within the host tenant's environment.

### BRIEF DESCRIPTION OF THE DRAWINGS

The present disclosure is detailed through various drawings, where like components or steps are indicated by identical reference numbers for clarity and consistency.

FIG. 1 is a block diagram of a computing system 100 that may be used to implement various components described in this disclosure.

FIG. 2 is a flow diagram of a cloud-based private access service.

FIG. 3 is a diagram of a cross-tenant private application access architecture.

FIG. 4 is a flow diagram showing an example flow of the present cross-tenant private application access.

FIG. 5 is a flowchart of a process for providing cross-tenant private application access.

### DETAILED DESCRIPTION OF THE DISCLOSURE

Again, the present disclosure relates to systems and methods for providing cross-tenant private application access. Various embodiments provide a cross-tenant federation framework. This novel approach simplifies and secures the process of sharing private application resources between partner organizations or tenants. By establishing a trusted federation relationship, backed by granular federated access policies and zero trust principles, the invention enables seamless, controlled, and secure access to private applications across tenant boundaries. It eliminates the need for complex network infrastructure, such as VPNs or MPLS, while providing a scalable, cost-effective, and user-friendly solution to drive collaboration in a secure manner. This invention provides significant benefits, including streamlined administration, enhanced user experience, cost savings, and stronger adherence to zero trust security models, making it an essential tool for modern inter-organizational partnerships.

### Example Computing System Architecture and Cloud Deployment

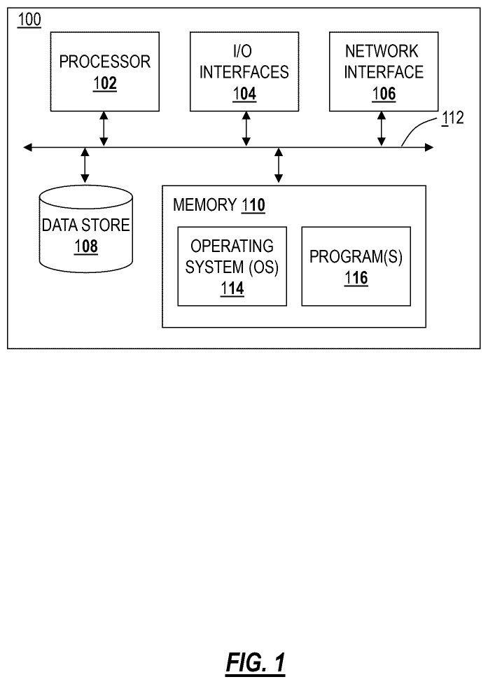

FIG. 1 is a block diagram of a computing system 100 that may be used to implement various components described in this disclosure. The computing system 100 can be implemented in many forms, including laptops, desktops, smartphones, tablets, physical servers, clusters of machines, virtual machines (VMs) running on hypervisors, or serverless computing frameworks. Regardless of the underlying infrastructure, the computing system 100 typically includes one or more processors 102, input/output (I/O) interfaces 104, a network interface 106, a data store 108, and memory 110. Note that FIG. 1 provides a simplified representation; in practice, the computing system 100 may include additional hardware and software elements. These components 102, 104, 106, 108, 110 are connected via a local interface 112, which can include various wired or wireless buses, high-speed interconnects, or switching fabrics. The local interface 112 may also include controllers, buffers, caches, drivers, repeaters, and receivers, along with addressing and control lines that facilitate efficient communication and resource sharing among components.

Each processor 102 is a hardware element—such as a central processing unit (CPU), multicore processor, system-on-chip (SoC), graphics processing unit (GPU), or a processing element within a larger compute cluster—designed to execute software instructions. These processors may be general-purpose or specialized, depending on performance, power efficiency, or workload needs. During operation, each processor 102 retrieves and executes instructions stored in memory 110, manages data exchanges with the data store 108, and oversees system 100 operations. In large-scale environments, multiple processors 102 may operate in parallel to handle elevated traffic and complex workloads.

The I/O interfaces 104 enable the computing system 100 to interact with external peripherals, allowing user input (e.g., via keyboards, touchscreens, or sensors) and system output (e.g., to displays or printers). Depending on the application, these I/O interfaces 104 may also support specialized devices used for maintenance, debugging, or other administrative functions. Meanwhile, the network interface 106 handles connectivity to external networks, which may include the Internet, private networks, or cloud environments. This network interface can use Ethernet, wireless local area networks (LANs), cellular connections, or virtualized cloud interfaces. By using secure transport protocols and encryption, data transmitted via the network interface 106 can remain protected, enabling the computing system 100 to participate safely in distributed or cloud-based deployments.

The data store 108 provides storage for both persistent and temporary data. It may include volatile memory (e.g., random access memory (RAM)) for high-speed operations and nonvolatile media (e.g., solid-state drives, hard disk drives, optical media) for long-term retention. In some deployments, the data store 108 may integrate with network-attached storage (NAS), storage area networks (SAN), or cloud-based storage solutions. These configurations can range from modest local setups to large-scale installations, potentially featuring global deduplication, compression, encryption at rest, and multi-site replication. The data store 108 can hold operational logs, configuration details, policy rules, program binaries, and cached computation results.

The memory 110 typically serves as the primary working memory for the processors 102. It may be composed of volatile elements (e.g., dynamic RAM (DRAM), double data rate (DDR), synchronous DRAM (SDRAM)) for fast access, as well as nonvolatile components such as flash memory or non-volatile RAM (NVRAM). The memory 110 can be distributed across nodes or servers to support the large-scale in-memory processing demanded by modern cloud services. Generally, the memory 110 stores the operating system (O/S) 114 and one or more programs 116. The O/S 114 handles core system tasks such as process scheduling, memory allocation, file management, and networking.

For Software-as-a-Service (SaaS) or other cloud-based components, the computing system 100 can be deployed in various ways: as a private cloud in a single organization's datacenter, a public cloud hosted by a third-party provider, or a hybrid cloud that combines both approaches for specific security, performance, or compliance considerations. Cloud computing abstracts physical hardware—servers, storage devices, and networks—into on-demand, scalable resources. This allows organizations to provision computing power, storage, and network bandwidth with minimal upfront costs, adjusting to fluctuating workloads seamlessly. According to the U.S. National Institute of Standards and Technology (NIST), cloud computing is “a model for enabling convenient, on-demand network access to a shared pool of configurable computing resources (e.g., networks, servers, storage, applications, and services) that can be rapidly provisioned and released with minimal management effort or service provider interaction.” Unlike traditional client-server environments, cloud computing typically delivers applications via a web interface, reducing the need for local installations and updates. Centralizing application hosting allows providers to uniformly release new features, apply security patches, and manage licensing. By using these SaaS models, end users can access software via browsers or lightweight clients, taking advantage of continuous improvements and frequent updates.

Various embodiments may utilize different forms of processing circuitry—general-purpose microprocessors, CPUs, digital signal processors (DSPs), network processors, GPUs, field programmable gate arrays (FPGAs), programmable logic devices (PLDs), or similar. This circuitry may be controlled by software, firmware, or a combination thereof, possibly alongside non-processor circuits to achieve the desired functionality. Specific tasks can also be handled by state machines or one or more application-specific integrated circuits (ASICs) that implement dedicated logic. In some cases, a hybrid approach may be adopted. Additionally, implementations can include a non-transitory computer-readable storage medium that stores computer-readable instructions. When executed by a device containing suitable processing circuitry, these instructions cause the system to perform the methods or algorithms described in this disclosure. Non-limiting examples of such storage media include hard disks, optical disks, magnetic devices, read-only memory (ROM) and its variants, flash memory, or other persistent/semi-persistent storage. Once stored, these instructions enable execution of the disclosed methods.

### Cloud-Based Private Application Access

Cloud-based internet security platforms such as the platform available from Zscaler, the applicant and assignee of the present application, are widely regarded for their ability to enable secure and seamless connectivity between users and applications regardless of location. The present disclosure references the Zscaler cloud platform as an example, but it will be appreciated that any cloud platform of the like can be adapted to implement the present systems and methods. One of its flagship services, Zscaler Private Access (ZPA), is a sophisticated Zero Trust Network Access (ZTNA) solution that enables secure, application-specific access to private applications hosted in any environment, whether in data centers, private clouds, or public clouds, without exposing these applications to the public internet. Unlike traditional Virtual Private Networks (VPNs), which often grant users broad access to an organization's network, ZPA (the private access service) operates based on zero trust principles and the concept of least privilege, ensuring users are granted access only to the specific applications they are authorized to use. This drastically reduces the attack surface and limits the risk of lateral movement in the event of a compromise.

At its core, the private access service connects users directly to private applications without ever placing them on the underlying network. Its operation centers around a few essential processes and components that work together to ensure secure, transparent, and policy-driven access. The first step begins when a user logs in from a device, which could range from a corporate-issued laptop to a personal smartphone. Upon login, the user's identity is authenticated through the organization's Identity Provider (IDP), such as Azure Active Directory, Okta, or Ping Identity. The private access service integrates with these IDPs to confirm the user's credentials and enforce the organization's access policies. Once authenticated, the private access service immediately applies Role-Based Access Controls (RBAC), which evaluate multiple factors, such as the user's role, group membership, device security posture, location, and time of access, to determine the specific applications the user is allowed to connect to. These permissions are based on granular security policies that are preconfigured in the private access service cloud portal.

Once the user is authenticated, the private access service relies on agent applications, a lightweight software agent installed on the user's device, to manage communication between the user and the cloud. The agent application securely forwards the user's traffic to a zero trust exchange, which acts as the heart of the private access service. The zero trust exchange is a distributed cloud platform where the user's request is inspected and matched against the organization's policies to determine the appropriate path to the destination private application. The key to the private access service's functionality is that it ensures users can only access individual applications they are explicitly authorized to use, and not the underlying network hosting the application. This is a significant departure from traditional VPNs, where users gain network-level access that can expose an organization's broader infrastructure to potential risks.

To connect users to private applications, the private access service employs application connectors, software components deployed within the environment where the private applications are hosted (e.g., an on-premises data center, Amazon Web Services, Microsoft Azure, Google Cloud Platform, etc.). These application connectors are lightweight, scalable, and designed for high availability. They establish outbound-only connections to the cloud, eliminating the need to open inbound firewall ports or place applications on the internet for accessibility. This design not only bolsters security by preventing external threats, but it also simplifies deployment by avoiding complex networking configurations. When a user sends a request to access an application, the cloud identifies the appropriate connector that has been deployed in the same location as the application and directs the user's traffic through that connector to the application server. The connection is established over an encrypted Transport Layer Security (TLS) tunnel, ensuring that all communication between the user and the application remains secure.

The application connectors play a critical role in maintaining the security and efficiency of the connection. Because they establish outbound-only connections, they prevent any inbound network communication, which dramatically reduces the potential attack surface. Multiple connectors can be deployed to ensure load balancing and redundancy. As part of the private access service's design, private applications remain “dark”, invisible to unauthorized users. Even if an attacker attempted to scan the network, the applications protected by the private access service would remain undetectable, effectively shielding them from discovery and attack.

The Cloud or the zero trust exchange acts as the mediator of all communication between users and private applications. This cloud-based system dynamically enforces security policies for every connection request. The policies evaluate conditions such as user identity, role, device type, operating system, compliance posture, application being accessed, and the user's geographic location. Once a request is approved, the private access service securely brokers the session between the user and the private application, often without requiring any reauthentication. This ensures a seamless experience for the end user while maintaining strict adherence to the organization's security policies.

At the same time, the private access service integrates seamlessly with existing infrastructure in a scalable manner. Organizations can use app segments, logical groupings of private applications based on IP addresses, hostnames, ports, or protocols, to define fine-grained access controls. For example, an app segment could represent all applications within a development environment or a particular department, like Human Resources (HR) or finance. These segments are tied to policies defined within the portal, allowing organizations to build least-privilege access rules that ensure users only see and access the application segments they need. To further enhance end-to-end security, the private access service integrates with Multi-Factor Authentication (MFA) solutions provided by the IDP, enabling an additional layer of verification for critical or sensitive applications.

Monitoring and logging are also vital aspects of the private access service's functionality. All activity, including user authentication events, application connection requests, and policy matches, is logged in the cloud. These logs can be streamed to external SIEM systems, such as Splunk or Microsoft Sentinel, enabling organizations to analyze events, detect anomalies, and meet compliance requirements.

In summary, the private access service operates as a secure, policy-driven bridge between users and applications, delivering application-specific connectivity while adhering to the principles of zero trust security. By using the agent application, the cloud, and application connectors, the solution ensures that users are granted secure, identity-driven access to private applications without exposing the organization's infrastructure to the public internet. Its cloud-first, zero trust approach not only eliminates the challenges associated with legacy VPNs but also improves security, scalability, and performance for modern organizations.

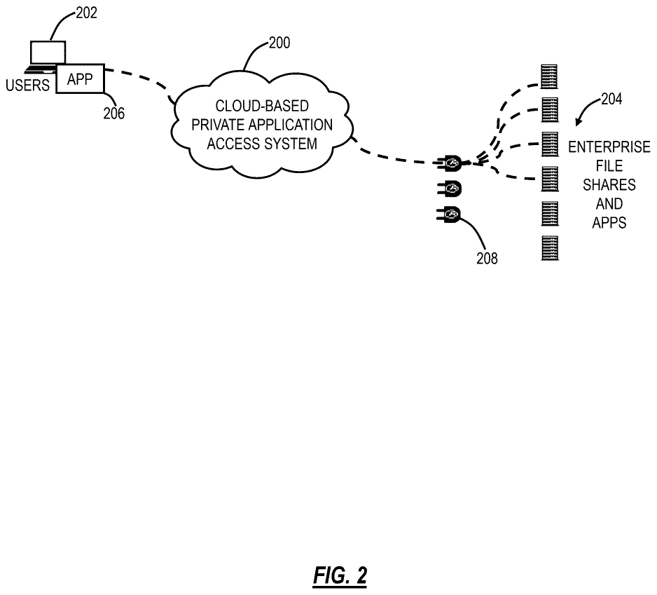

FIG. 2 is a flow diagram of a cloud-based private access service. The private access service follows a clear, step-by-step process to securely connect a user 202 to a private application 204. Let's consider the use case of a remote employee/user 202 trying to access an internal HR application hosted in the company's internal AWS Virtual Private Cloud (VPC). The process begins when the user 202 initiates the connection by either opening the agent application 206 (a lightweight application installed on their device) or directly attempting to access the HR application through their browser. The agent application 206, which is always running on the user's device, intercepts the traffic and forwards the request to the cloud-based private access service 200 for processing. To proceed, the user must be authenticated. The cloud (cloud-based private access service 200) redirects the login attempt to the organization's IDP, such as Okta or Azure Active Directory, to confirm the user's credentials, device posture, and, if set up, an MFA step. Once the user's identity is verified, the cloud-based private access service 200 retrieves the user's role, group membership, location, device attributes, and access permissions from the IDP.

Next, the cloud-based private access service 200 evaluates the user's request against the organization's access policies, which are designed to enforce zero trust principles. These policies take into account information such as the user's role (e.g., HR employee), the device security posture (e.g., valid antivirus software), geographic location, and the specific application being requested (e.g., the HR platform hostname: hr-app.company.internal). If the request complies with all policy requirements, the cloud-based private access service 200 approves it and identifies the app segment that matches the requested application. app segments are logical groupings of applications defined by the company's IT administrators, listing specific attributes like domain names, IP ranges, ports, and protocols to simplify policy enforcement. In this case, the HR application resides within a particular App Segment hosted in the AWS VPC. Based on the App Segment information, the cloud-based private access service 200 determines which application connector 208 is associated with the target application 204 and prepares to broker the connection.

The application connector 208 serves as the intermediary between the cloud-based private access service 200 and the private applications 204. Deployed within the same AWS VPC as the HR application, the application connector 208 maintains an outbound-only connection to the cloud-based private access service 200, which eliminates the need for inbound traffic, thus maintaining a stronger security posture. Once the cloud-based private access service 200 validates the user request, it establishes a secure end-to-end tunnel between the user's device and the private application using encrypted TLS. The user 202 is now seamlessly connected to the application 204 through this encrypted point-to-point communication channel. Unlike a legacy VPN, the user is only granted access to the specific application they requested, not the broader network environment. This ensures that other resources in the same VPC remain “dark” (invisible) and are not accessible or discoverable by the user, further reducing the organization's attack surface and minimizing the risk of lateral movement by malicious actors.

Throughout the session, the cloud-based private access service 200 continuously monitors the user's connection, ensuring compliance with configured policies. For instance, if the user's device becomes non-compliant (e.g., antivirus is disabled), access can be revoked immediately. Simultaneously, the user's activity, including authentication details, policy evaluations, and session logs, is recorded by the cloud. These logs are vital for auditing, analytics, and compliance purposes and can be streamed in real-time to external Security Information and Event Management (SIEM) tools like Splunk or Microsoft Sentinel. When the session ends, whether the user logs out, becomes idle beyond an allowed timeout limit, or disconnects manually, the cloud-based private access service 200 terminates the connection to ensure security. If the user 202 wishes to reconnect, they must repeat the authentication and policy evaluation process.

In this entire flow, several components work cohesively to enable secure connectivity. The agent application 206 on the user's device captures and forwards the connection requests to the cloud-based private access service 200. The zero trust exchange, within the cloud, evaluates user access policies, authenticates credentials through the IDP, and determines the appropriate application connector 208 to broker the connection to the requested application 204. The application connectors 208 establish outbound-only tunnels to facilitate secure, policy-driven access, with the applications themselves remaining hidden from unauthorized discovery. This step-by-step workflow demonstrates how the cloud-based private access service 200 delivers seamless and secure, identity-based connectivity to private applications. The cloud-based private access service 200 not only enhances security through zero trust principles but also streamlines user experience by eliminating the complexities of traditional VPNs, requiring no changes to internal applications or networking infrastructure.

### Cross-Tenant Private Application Access

The cloud-based private access service 200 is a widely used zero trust architecture solution designed to provide secure and seamless access to private applications. However, the cloud-based private access service 200 currently faces challenges in scenarios where cross-tenant application sharing is required, such as partnerships between organizations. Consider the example of two cloud customers/tenants who are business partners: Customer 1, who owns applications A, B, and C, and Customer 2, who owns applications X, Y, and Z. Customer 1 needs secure access to applications X and Y from Customer 2's environment, while Customer 2 requires access to application B from Customer 1's environment. Unfortunately, private access services, such as the service described herein, currently lacks an effective and streamlined mechanism for this type of cross-tenant resource sharing, posing significant challenges for collaboration and productivity. Existing solutions are cumbersome and inflexible, creating a poor user experience. Meanwhile, alternative approaches like Multiprotocol Label Switching (MPLS) or site-to-site VPNs introduce operational complexities, increased costs, and delays in establishing secure access to shared applications.

One of the primary problems with current partner tenant login mechanism is their inability to allow simultaneous access to applications across multiple tenants. End users must log in to the agent application twice, once for the primary tenant and then a second time for the partner tenant, resulting in a complicated and inconvenient user experience. Further, logging into the partner tenant automatically revokes access to the primary tenant's applications, forcing users to toggle between profiles to access applications. This is especially problematic for organizations where end users frequently need to access applications from multiple tenants, making the partner tenant login process inefficient for day-to-day operations. Additionally, the configuration and enrollment process for enabling partner login is highly manual since there is no mechanism to pre-configure or push partner login profiles to users. This leaves end users to handle the configuration themselves, which can lead to further frustrations, delayed deployments, and potential misconfigurations.

Another challenge arises from alternative solutions used by some organizations, such as network-based approaches like Multiprotocol Label Switching (MPLS), site-to-site VPNs, or private Wide Area Network (WAN) routing between tenants. These options introduce significant complexity in terms of network architecture, cost, and time-to-deploy. For example, if an agency or organization needs to allow access to applications hosted by a partner, it must implement additional private connectivity or routing agreements between the two tenants, often using MPLS or site-to-site VPNs. While these approaches technically work, they deviate from the private application access service's ideal use case of leveraging the internet as the transport layer for secure connections and instead rely on outdated, hardware-intensive methods that are expensive and labor-intensive to set up and maintain. This complexity is further compounded by the need for firewalls, Access Control Lists (ACLs), and routing configurations between data centers, which require additional operational approval cycles from both partners. These processes often delay the implementation of shared application access, creating unnecessary bottlenecks. Even worse, some organizations resort to using IP-based whitelisting, which bypasses authentication altogether, making the setup not only complex but also fundamentally insecure.

The inefficiencies and complexities in enabling cross-tenant application access also significantly impact the end-user experience and productivity. For instance, many customers use the cloud-based private application access service and have more than 20 tenants each to manage. A health service provider, for example, operates across 17 tenants. For such customers, switching between 16 or 17 partner login profiles is practically impossible on a daily basis, leading to delays in accessing critical private applications. Compounding this problem, logging into a partner tenant to access shared applications disconnects the user from their primary tenant entirely, cutting off access to private applications managed by their own organization. This means users cannot access applications from two tenants concurrently, further disrupting workflows and reducing productivity. Given the frequency with which some users need to access resources across multiple tenants, this limitation has become a major hurdle for organizations relying on such private access systems for secure, efficient access.

Organizations using such private access systems often encounter challenges in specific scenarios, such as Business-to-Business (B2B) collaboration and Mergers or Acquisitions (M&A). These use cases highlight the limitations of current solutions, particularly when it comes to cross-tenant application access and tenant migrations.

In the B2B private app use case, organizations frequently require a seamless and efficient method for users in one tenant to access private applications hosted in another tenant. This can be particularly complex for federal agencies and Managed Security Service Providers (MSSPs), some of whom maintain more than 15 partners and share multiple private applications between tenants. Currently, most of these organizations rely on a complicated, mesh-like network architecture implemented using MPLS or site-to-site VPNs to enable such access. This approach introduces significant operational overhead, existing methods like partner login require users to juggle multiple logins and force organizations to deploy dedicated app connectors for each partner. This not only increases the risk of configuration errors but also complicates the setup and management of application access policies. Furthermore, the lack of a standardized process for secure cross-tenant communication poses security risks, as the current implementation does not enforce a true zero-trust model. As a result, organizations struggle to create consistent access policies and ensure secure data exchange between partners. Moreover, the existing setup lacks scalability for large-scale environments. Organizations with numerous partners and users must repeatedly configure and deploy MPLS links, site-to-site connections, or additional application connectors 208 for every partner, leading to inefficient resource utilization and operational bottlenecks. These practices increase both capital and operational expenses for organizations while limiting their ability to scale effectively to meet future growth needs.

In the M&A use case, businesses undergoing mergers or acquisitions face significant challenges in managing cross-tenant access and migrating users and applications between tenants. Current frameworks provide no direct mechanism for seamless access to private applications across two tenants during the transition. This creates substantial technical and administrative hurdles, referred to as tenant migration challenges. Both merging organizations often need to deploy their application connectors within each other's data centers in order to manage private application access, introducing additional infrastructure costs and resource requirements. These deployments increase costs for the organizations involved. Another major issue is the potential for disruption to business operations during the migration. The reconfiguration of access policies, network setups, and infrastructure during the merger process can lead to downtime and operational delays, negatively impacting business continuity. Adding to this complexity, merging organizations often have disparate access policies, architectures, and configurations, resulting in complex policy management. Reconciling these policies to align with a standardized framework is time-consuming and can introduce security gaps during the transition period. These challenges make tenant migrations a labor-intensive process and hinder operational efficiencies during mergers or acquisitions.

Both of these use cases highlight the need for a more streamlined, secure, and scalable solution. The complexity of current methods not only impacts security and scalability but also increases operational costs and disrupts business agility, underscoring the importance of enhancing the ability to support cross-tenant scenarios effectively.

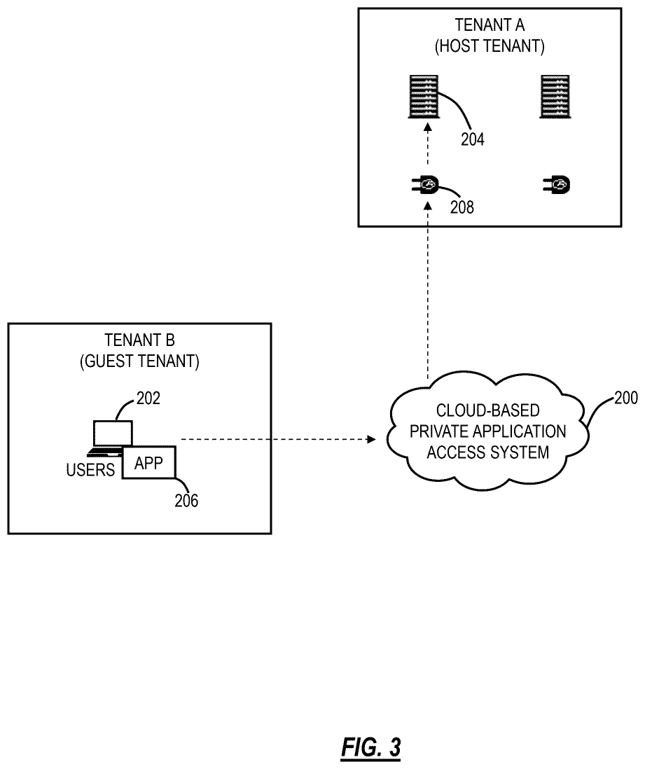

FIG. 3 is a diagram of a cross-tenant private application access architecture. The present disclosure introduces a cross-tenant federation system designed to facilitate seamless application sharing between tenants. In various embodiments, the present systems and methods allow private applications 204 of a first tenant, in this case Tenant A 302 (the host tenant), to be accessible by users 202 of a second tenant, in this case Tenant B 304 (the guest tenant). This access is facilitated through the cloud-based private application access system 200 as described herein.

This cross-tenant private application access feature allows users from one organization to access private applications hosted within another organization without the need for cumbersome workflows such as multiple logins, deployment of dedicated app connectors, or the setup of additional network infrastructure like site-to-site VPNs or MPLS links. Most critically, this feature aligns with the principles of zero trust architecture, ensuring secure access to shared resources by enforcing granular policies, maintaining the least-privilege principle, and eliminating the risks associated with traditional network-based solutions. The cross-tenant federation feature would establish a trusted relationship between tenants while providing both organizations with fine-grained control over shared resources and user access. This innovation not only simplifies cross-tenant collaboration but also improves scalability, operational efficiency, and the overall security posture of organizations leveraging cloud-based private application access services.

The cross-tenant federation feature offers substantial benefits compared to the existing approaches for enabling B2B private application access. First and foremost, it drastically reduces the time required to establish cross-tenant private application access. What currently takes 30-60 days to set up using traditional methods like MPLS or site-to-site VPNs could instead be achieved in under one hour with the federation feature. Additionally, it eliminates the need for additional network infrastructure, such as private WAN routing (MPLS) or VPN plumbing, as cross-tenant communication would be fully handled by the cloud-based private access service's zero trust architecture. Organizations would no longer need to deploy additional application connectors 208 for every partner, further simplifying the setup and reducing operational overhead. This also translates into significant cost savings on infrastructure, as customers no longer need to invest in expensive MPLS lines or deploy application connectors 208 redundantly across their network and partner environments. Furthermore, the federation capability would eliminate the need to provision extra user accounts in external IDPs to accommodate guest users, representing another layer of cost savings and reducing administrative complexity.

Another key benefit is the ability to enact granular access control and visibility over third-party users. Organizations could define and enforce strict access policies, ensuring that external users only access specific private applications or resources to which they are authorized. These policies account for user identity, role, device posture, location, and other contextual conditions. In addition to controlling access, organizations gain complete visibility into third-party users, allowing them to monitor activity, device compliance, and access patterns across federation boundaries. This aligns with zero trust principles by providing full contextual insights into who is accessing shared applications and under what conditions. Importantly, the federation feature allows concurrent access to private applications across multiple tenants, meaning users could seamlessly access resources in both their primary organization's tenant and a partner's tenant without constantly logging in and out or disrupting their workflows. This ensures an intuitive and efficient end-user experience that minimizes friction, reduces effort, and boosts productivity across collaborative environments.

Perhaps the most critical advantage of the cross-tenant federation feature is its robust emphasis on security, ensuring that all access is firmly grounded in zero trust architecture principles. By eliminating traditional network-level trust, such as in MPLS and VPN setups, the feature aligns with modern security standards by maintaining application-specific access rather than exposing broader networks. It also eliminates risky practices like IP whitelisting, which bypass authentication steps entirely, thereby ensuring that all access is identity-driven and fully governed by the cloud-based private access service's granular access policies. The entire system ensures that application sharing is handled securely and efficiently, protecting sensitive resources from unauthorized discovery or misuse.

The core components and terminology associated with the cross-tenant federation feature provide a foundational framework for understanding how secure application sharing is managed between tenants. At the heart of this system is the host tenant, the company, tenant, or business that owns the private applications being accessed. On the other hand, the guest tenant refers to the organization or business that requires access to these private applications owned by the host tenant. Within these organizations, key roles are defined. The host tenant admin is the administrator responsible for managing application sharing configurations for the host tenant, while the guest tenant admin is the administrator working on behalf of the guest tenant to facilitate user access to the shared resources. The application consumer represents the end user from the guest tenant who actually accesses the private applications shared by the host tenant.

The management of tenant-to-tenant trust and cross-organization application sharing takes place within a tenant management interface, a user-friendly User Interface (UI) screen inside the private access service 200 that enables administrators to monitor and manage the trust relationships between partner tenants. This is an integral part of the zero trust tenant framework, which outlines the process of securely establishing trust between two tenants from different organizations for the purpose of enabling private application access. At the heart of these collaborations lies the Acceptable Use Policy (AUP) for resource sharing policy, which defines the terms and conditions that must be agreed upon by both parties before any applications can be shared. This ensures that resource sharing adheres to organizational standards, compliance requirements, and security protocols.

To initiate tenant federation, a tenant federation request is submitted by the guest tenant to the host tenant. Once the request is reviewed and approved, the provisioning process begins, wherein access is granted to the specific applications that were requested. This step involves fine-grained control over which users or groups from the guest tenant are given access to particular private applications in the host tenant's environment. If, at any point, the access is no longer required or the relationship between the two organizations changes, the de-provisioning process is initiated to revoke previously granted access. Together, these components and processes ensure that cross-tenant application sharing is conducted securely, efficiently, and in strict adherence to the zero trust principles that form the foundation of the cloud-based private application access service 200.

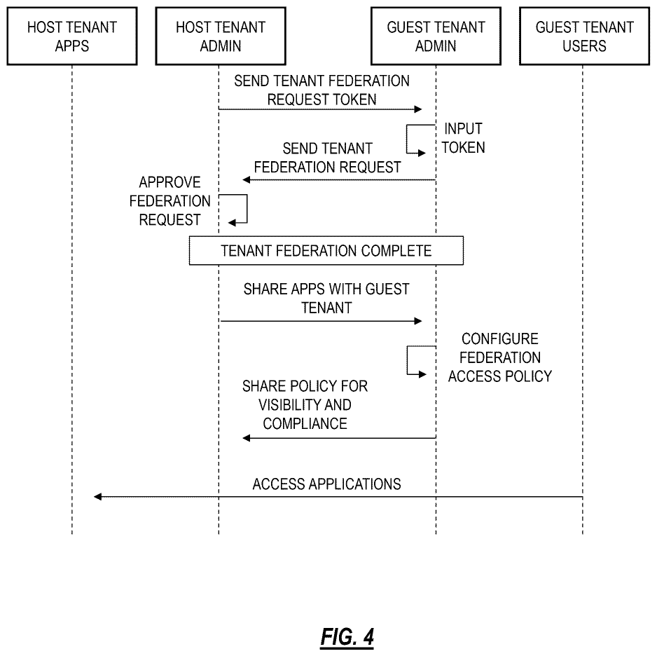

FIG. 4 is a flow diagram showing an example flow for establishing cross-tenant private application access. The workflow for enabling cross-tenant federation in the cloud-based private application access system begins with allowing the host tenant administrator, who initiates the process by generating and sending a tenant federation request token to the guest tenant administrator. This token serves as a unique identifier for establishing trust between the two tenants and is shared securely between the administrators. Once the guest tenant administrator receives the token, they input it into their interface/portal, effectively acknowledging the request to federate with the host tenant. At this stage, the host tenant administrator reviews and completes the tenant federation request, officially establishing the trust relationship between the two tenants.

After the federation is established, the host tenant administrator can create app segments within the portal, which includes private applications or resources that are intended to be shared with the guest tenant. The administrator then shares these app segments with the guest tenant, specifying the parameters of access. Once the shared app segments are received, the guest tenant administrator configures a federated access policy. This policy defines rules such as which users or groups within the guest tenant can access the shared applications, as well as any contextual conditions like device posture or geographic restrictions to enforce zero trust principles.

Finally, with the access policy in place, an end user from the guest tenant can seamlessly start accessing the private applications of the host tenant. The entire process ensures that access is secure, managed administratively at both ends, and adheres to zero trust principles while providing a smooth and intuitive experience for end users. By leveraging this workflow, organizations can efficiently collaborate across tenants without the need for complex configurations or additional infrastructure.

The federated access policy is a critical component in facilitating secure and controlled access between two partner tenants. This policy is specifically designed to manage and enforce access to selected applications or application segments shared between the host tenant (the tenant that owns the application) and the guest tenant (the tenant that consumes the application). By leveraging this policy, the two organizations can establish a trusted connection while maintaining granular, transparent, and secure access controls.

The federated access policy is primarily configured and saved within the guest tenant's environment, as it is the responsibility of the guest tenant admin to define who within their organization will access the shared applications and under what conditions. To ensure transparency and alignment between both parties, the same policy is also shared with the host tenant in a “Read-Only” mode. This read-only view allows the host tenant admin to review the guest tenant's policy to ensure consistency with the agreed terms for application access. While the host tenant has no capability to edit or modify the policy, the ability to oversee its configuration allows the host tenant admin to collaborate with the guest tenant admin if discrepancies or inconsistencies arise, ensuring mutual trust and alignment.

The policy evaluation process begins when a user from the guest tenant attempts to access one of the shared applications. The first step occurs on the guest tenant's agent applications 206, where the user's credentials and device posture are validated against the policy defined within the guest tenant. These checks can include identity verification through the guest tenant's IDP, device compliance posture (e.g., OS version, antivirus status), and other contextual attributes configured as part of the federated access policy. Once the policy is successfully evaluated, the agent application 206 of a user's device performing the application access establishes a connection with the nearest broker in the cloud infrastructure. The broker already holds the federated access policy information and reassesses it to confirm the user, and their connection request meet all defined criteria. If the broker determines that all policy requirements are satisfied, it identifies the appropriate app connector 208 within the host tenant environment to facilitate the connection to the desired application. The app connector 208 then securely establishes a connection between the shared application and the broker, enabling the guest user to easily and securely access the host tenant's resource.

In addition to access control policies, timeout policies for shared applications are configured and enforced by the host tenant. These timeout policies ensure that guest tenant users are re-authenticated within a predefined timeframe, maintaining security and adhering to zero trust principles. Once the timeout expires, the guest user will be required to reauthenticate via their IDP, ensuring that access remains session-specific and reducing the risk of prolonged, unauthorized connections. This approach allows the host tenant to retain control over the duration and security of access to its resources while ensuring that users from the guest tenant comply with the same rigorous security standards applied within the host tenant's environment.

Therefore, the federated access policy provides a structured, secure, and transparent framework that enables the host and guest tenants to collaborate effectively while maintaining strict control over access to shared applications. By allowing the guest tenant to define access policies, granting the host tenant visibility through a read-only view, evaluating policies dynamically during every access request, and enforcing timeout rules for reauthentication, this system delivers a comprehensive, zero trust approach to cross-tenant application sharing. This ensures not only ease of use for end users but also high levels of security and robust administrative control for both parties.

Both the host tenant administrator and the guest tenant administrator have the ability to manage the tenant federation status, which governs the operational state of the trust relationship between two tenants. Based on specific use cases or organizational needs, the tenant federation status can transition between three key states: Pause (Disable), Active (Enable), and Terminate (Revoke). These states are designed to provide flexibility, maintain security, and ensure proper oversight during the lifecycle of a partnership.

The first state, disable, can be used when the trust relationship needs to be temporarily paused. For example, if a security breach or other unforeseen issue arises, organizations may decide to immediately halt tenant federation to prevent potential misuse. When the federation is disabled, all access from guest tenant users to host tenant applications is immediately denied or blocked. This action not only ensures that unauthorized activity is prevented but also gives both organizations time to investigate and resolve the issue. Additionally, the disable state must remain synchronized between both tenants. If the host tenant administrator disables the tenant federation, the status will automatically update to “disabled” on the guest tenant's UI, ensuring consistent visibility and alignment between the two parties.

The second state, Enable, indicates that tenant federation is fully operational and traffic is flowing as expected. After a temporary pause or resolution of concerns (e.g., following a security breach), the federation relationship can be re-enabled by either administrator via their respective portals through the cloud-based private application access system/service. Once tenant federation is re-enabled, guest tenant users regain seamless access to the host tenant's shared applications according to the previously configured policies. This state is the default mode of operation when the partnership is active, and it ensures that both organizations can collaborate securely and efficiently.

The third state, Revoke (Terminate), is used when the trust relationship between the two organizations is permanently dissolved, such as when Company A and Company B are no longer business partners. When this state is activated, all access for guest tenant users to the host tenant's private applications is immediately denied or blocked, ensuring there is no lingering access to sensitive resources. Additionally, all configurations and policies related to the specific partner tenant are completely deleted from both tenants, ensuring a clean and irreversible termination of the relationship. To prevent accidental revocation due to human error, a user prompt is presented to the administrator, requiring them to explicitly confirm the action by typing a confirmation message (e.g., “Revoke” or “Terminate”). This safeguard ensures that such critical actions are only carried out intentionally and with full administrator oversight.

The present systems and methods introduce robust backup, restore, and deletion capabilities aimed at ensuring the continuity, security, and reliability of cross-tenant relationships in scenarios involving shared app segments and associated policies. These features address potential challenges during the lifecycle of app segment management, providing administrators with tools to safeguard dependent policies and minimize disruption during changes like deletions or restorations.

The backup and restore process begins with policy-dependent validation as a safeguard against unintended disruptions. If an app segment shared between tenants is marked for deletion by the host tenant administrator, the system will first validate whether any active policies depend on that segment, i.e., any B2B or M&A policies that utilize the cross-tenant private application access feature described herein. The host tenant administrator will be notified with a warning about the potential impact on shared access and workflows, ensuring they are aware of the consequences. In cases where the deletion would disrupt critical workflows, the system restricts the deletion unless explicitly overridden by the host tenant administrator. This validation ensures that app segments critical to ongoing business processes cannot be removed inadvertently.

Another key feature is policy backup synchronization during deletion and restoration. When an app segment is deleted on the host tenant's side/environment, the corresponding app segment is not only removed from the guest tenant's view but also from the guest tenant's agent applications if it has been configured for use by end users. A key consideration is what happens to the guest tenant's access policies that reference the deleted app segment. During backups and restorations, the system ensures that not only the app segment definitions are saved but also any associated policies, so that restoring an app segment automatically reinstates its dependent policies. This avoids unintentional disruptions to B2B or M&A workflows and guarantees a seamless restoration of services.

To maintain the integrity of restored configurations, a restore integrity check is performed, ensuring that any app segment being restored is reconnected with its original policies and that these policies are compatible with the current configurations of both tenants. This validation prevents issues such as broken connections or policy mismatches that could arise from restoring outdated app segment configurations. Additionally, any deletion or restoration activity will trigger detailed audit and logging, including information on the affected app segments, dependent policies, and associated administrative actions. These records are essential for compliance purposes and troubleshooting in the event of policy misconfigurations or unexpected disruptions.

When an app segment is deleted, the system also includes a mechanism for guest tenant notifications. The relevant guest tenant administrator will be notified immediately, ensuring transparency and allowing them to take appropriate actions, such as adjusting access policies or notifying end users about potential service impacts. For scenarios where conflicts arise, such as restoring an app segment that duplicates an existing one or brings back outdated policies, administrators from both tenants will be alerted.

In various embodiments, to reduce service interruptions, a grace period for deletion is introduced. This feature temporarily retains deleted app segments for a set time, during which they can be restored with minimal impact to dependent workflows. This grace period minimizes downtime for guest tenant users and provides administrators with added flexibility in handling deletions, particularly if they were invoked in error. Additionally, cross-tenant policy enforcement ensures that restored app segments are immediately propagated to all associated cloud brokers so that guest tenant users can promptly regain access to applications. Every restoration triggers an automatic policy update, ensuring that access is reinstated without delays or manual intervention.

To improve the usability of these features, thoughtful UI considerations include displaying clear warnings and potential impacts during the backup, restore, or deletion workflows when shared app segments are involved. For instance, administrators receive visual cues about how their actions might affect dependent policies, other tenants, or end users. These warnings ensure that administrators are fully informed of their decisions and can act in a way that minimizes unintended disruptions.

Various embodiments discussed within the scope of this disclosure describe a robust system designed to facilitate cross-tenant access to private applications, enabling seamless collaboration across organizational boundaries. This system is engineered to provide secure and efficient mechanisms for granting access to private applications between separate entities, even if they operate within different tenants. Furthermore, the present systems and methods go beyond the traditional limitations of private application access, offering a versatile solution for sharing private applications between two distinct organizations. Importantly, this sharing capability is not contingent upon whether the organizations are directly associated with a private application access service, such as Zscaler Private Access (ZPA). By removing dependency on a specific access service, the described system fosters interoperability and flexibility, making it possible for organizations to efficiently share resources and collaborate securely, regardless of their affiliations with specific application access platforms. Such advancements underline the adaptability and innovation of the methods presented, paving the way for enhanced cross-organizational collaboration in environments where private applications must remain secure and restrictive yet accessible when necessary.

### Process for Cross-Tenant Private Application Access

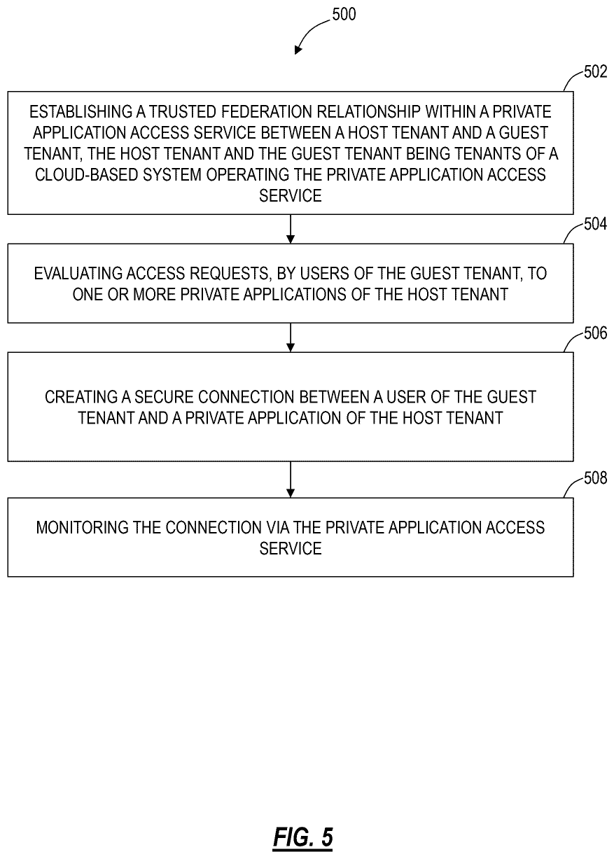

FIG. 5 is a flowchart of a process 500 for providing cross-tenant private application access. The process 500 can be contemplated as a methods having steps, processing devices configured to implement the steps, a cloud-based system configured to implement the steps, and as a non-transitory computer-readable medium storing instructions for programming one or more processors to execute the steps. The process 500 includes establishing a trusted federation relationship within a private application access service between a host tenant and a guest tenant, the host tenant and the guest tenant being tenants of a cloud-based system operating the private application access service (step 502); evaluating access requests, by users of the guest tenant, to one or more private applications of the host tenant (step 504); creating a secure connection between a user of the guest tenant and a private application of the host tenant (step 506); and monitoring the connection via the private application access service (step 508).

The process 500 can further include wherein an application connector of the host tenant is used to broker communication to the private application. The evaluating can include evaluating policies established by the guest tenant, wherein the policies govern which users are allowed access to which private applications of the host tenant. Monitoring the connection can include evaluating, based on policy, session timeout intervals and monitoring device compliance. The steps can include terminating the connection responsive to any policy violations. The secure connection between the user and the private application can be facilitated through a broker of the cloud-based system which evaluates federated access policy to ensure compliance. The broker can be adapted to identify an appropriate application connector within the host tenant's environment for creating the secure connection. Prior to establishing the connection, the steps can include verifying the users device posture including operating system type, operating system version, and antivirus status. The secure connection can be initiated by an agent application of a device associated with the user, which forwards an access request to a nearest cloud-based system broker for policy evaluation and enforcement. Upon successful policy evaluation, the connection allows application-specific access while prohibiting lateral movement within the host tenant's environment.

### Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A method for securely managing cross tenant access to private applications, the method comprising steps of:
establishing a trusted federation relationship within a private application access service between a host tenant and a guest tenant, the host tenant and the guest tenant being tenants of a cloud-based system operating the private application access service;
evaluating access requests, by users of the guest tenant, to one or more private applications of the host tenant;
creating a secure connection between a user of the guest tenant and a private application of the host tenant; and
monitoring the connection via the private application access service.

2. The method of claim 1, wherein an application connector of the host tenant is used to broker communication to the private application.

3. The method of claim 1, wherein the evaluating includes evaluating policies established by the guest tenant, wherein the policies govern which users are allowed access to which private applications of the host tenant.

4. The method of claim 1, wherein monitoring the connection includes evaluating, based on policy, session timeout intervals and monitoring device compliance.

5. The method of claim 4, wherein the steps include terminating the connection responsive to any policy violations.

6. The method of claim 1, wherein the secure connection between the user and the private application is facilitated through a broker of the cloud-based system which evaluates federated access policy to ensure compliance.

7. The method of claim 6, wherein the broker is adapted to identify an appropriate application connector within the host tenant's environment for creating the secure connection.

8. The method of claim 1, wherein prior to establishing the connection, the steps include verifying the users device posture including operating system type, operating system version, and antivirus status.

9. The method of claim 1, wherein the secure connection is initiated by an agent application of a device associated with the user, which forwards an access request to a nearest cloud-based system broker for policy evaluation and enforcement.

10. The method of claim 1, wherein, upon successful policy evaluation, the connection allows application-specific access while prohibiting lateral movement within the host tenant's environment.

11. A non-transitory computer-readable storage medium having computer-readable code stored thereon for programming one or more processors to perform steps of:
establishing a trusted federation relationship within a private application access service between a host tenant and a guest tenant, the host tenant and the guest tenant being tenants of a cloud-based system operating the private application access service;
evaluating access requests, by users of the guest tenant, to one or more private applications of the host tenant;
creating a secure connection between a user of the guest tenant and a private application of the host tenant; and
monitoring the connection via the private application access service.

12. The non-transitory computer-readable storage medium of claim 11, wherein an application connector of the host tenant is used to broker communication to the private application.

13. The non-transitory computer-readable storage medium of claim 11, wherein the evaluating includes evaluating policies established by the guest tenant, wherein the policies govern which users are allowed access to which private applications of the host tenant.

14. The non-transitory computer-readable storage medium of claim 11, wherein monitoring the connection includes evaluating, based on policy, session timeout intervals and monitoring device compliance.

15. The non-transitory computer-readable storage medium of claim 14, wherein the steps include terminating the connection responsive to any policy violations.

16. The non-transitory computer-readable storage medium of claim 11, wherein the secure connection between the user and the private application is facilitated through a broker of the cloud-based system which evaluates federated access policy to ensure compliance.

17. The non-transitory computer-readable storage medium of claim 16, wherein the broker is adapted to identify an appropriate application connector within the host tenant's environment for creating the secure connection.

18. The non-transitory computer-readable storage medium of claim 11, wherein prior to establishing the connection, the steps include verifying the user's device posture including operating system type, operating system version, and antivirus status.

19. The non-transitory computer-readable storage medium of claim 11, wherein the secure connection is initiated by an agent application of a device associated with the user, which forwards an access request to a nearest cloud-based system broker for policy evaluation and enforcement.

20. The non-transitory computer-readable storage medium of claim 11, wherein, upon successful policy evaluation, the connection allows application-specific access while prohibiting lateral movement within the host tenant's environment.
